(19) United States
(12) Patent Application Publication
(10) Pub. No.: US 2015/0330419 A1
(43) Pub. Date: Nov. 19, 2015

(54) COMPRESSED AIR ENERGY STORAGE SYSTEM

(71) Applicant: Dimitre KARAMANEV, London (CA)

(72) Inventor: Dimitre Karamanev, London (CA)

(21) Appl. No.: 14/652,641

(22) PCT Filed: Dec. 16, 2013
(86) PCT No.: PCT/CA2013/050972

§ 371 Date: Jun. 16, 2015

Related U.S. Application Data
(60) Provisional application No. 61/737,807, filed on Dec. 16, 2012.

(51) Int. Cl. F15B 15/14; F15B 1/027

(52) U.S. Cl. CPC F15B 15/1409; F15B 1/027

(57) ABSTRACT

The present disclosure is related to a method of pseudo-isothermal energy conversion between mechanical and pneumatic energy comprising the steps of: providing a gas/liquid unit wherein the gas/liquid unit may be a compression unit filled with gas and a liquid storage unit containing liquid, the compression unit having thermally conductive walls; compressing the gas by pumping the liquid into the compression unit via a liquid pump and producing compressed gas; concurrently transferring the heat created during the compression step through the walls of the compression unit; and transferring the compressed gas into a compressed gas storage unit and thereby storing energy in the form of pneumatic energy of a compressed gas. The method may also include expansion steps wherein the stored pneumatic energy in the form of compressed gas is converted into mechanical energy

### FIELD OF THE DISCLOSURE

This disclosure relates to energy storage systems and in particular energy storage systems that use compressed air.

### BACKGROUND

The compression of gases is a very important process in many technologies. When compressing (reducing the volume of) an ideal or close to ideal gas, heat is produced in addition to increase in the gas pressure. When all the heat produced due to gas compression is removed from the compressing gas by heat exchange with the surroundings during the compression, the process is isothermal.

The expansion of a gas is a process opposite to the process of compression. Therefore, during the expansion, the gas pressure is decreased and heat is consumed by the expanding gas. In order to achieve isothermal conditions, the amount of heat consumed by the expanding gas must be supplied by heat transfer from the surroundings to the expanding gas during the expansion.

In chemical and other industries pseudo isothermal compression is used in order to avoid excessive heating of the compressed gas as well as to minimize the mechanical work for gas compression. When gas compression is used for the storage of energy in compressed air energy storage systems (CAES), the isothermal regime allows to minimize the energy loses, and therefore, maximizes the overall storage efficiency. In addition, the excessive drop of the gas temperature in an adiabatic expander often requires the burning of natural gas in order to maintain the gas temperature above the minimum required level.

True (theoretical) isothermal compression/expansion is impossible in the engineering practice. One of the main reasons is the requirement for a zero temperature difference between the compressed/expanded gas and the surroundings. That requires either infinite heat transfer area, infinite heat transfer time or both. The real compression/expansion processes can approach the theoretical isothermal compression/expansion to a different degree. The term pseudo isothermal compression is used here to describe a compression which is between isentropic and truly isothermal one. In pseudo isothermal compression some heat is removed from the compressed gas, but it is less than the amount of heat to be removed for truly isothermal compression. In addition, in many cases heat is not removed during the process of gas compression, which makes the process even less close to the theoretical isothermal one. Therefore, the temperature at the end of a real compression or expansion process is between that of an ideal isentropic and ideal isothermal compression or expansion. The above analysis shows that the heat transfer area and the time of the heat transfer are of a great importance for approaching the theoretical isothermal compression or expansion.

One of the most popular methods to achieve pseudo isothermal compression is based on the use of several compressors in series with intercooling between them. Another possibility for a pseudo isothermal compression is the use of coolants in a jacket or other cooling passages, which contact the compressing gas. The isothermal efficiency of these types of compressors is quite low because of the significant temperature increase due to the insufficient heat exchange between the compressing gas and the surroundings. Similar methods are used in the case of gas expansion.

Recently, pseudo isothermal reciprocating compressors/expanders with direct gas-liquid cooling/heating were described (US2013291960; US2013145764). The basic idea is similar to the idea behind the first steam engine proposed by Thomas Newcomen back in 1712. During the compression, water is sprayed into the compression cylinder of a reciprocating compressor. As a result, there is a direct heat exchange between the compressing gas and the liquid droplets. The heated liquid is removed from the compression cylinder and is cooled back to its initial temperature in a separate unit. While the efficiency of this type of compressors is higher that these with intercooling and with jacket cooling, there is still a significant temperature increase, and therefore, relatively low isothermal efficiency. In addition, the system is quite complex due to the two-phase flow in the cylinder, and the need to transport the cooling liquid and to cool it in a separate heat exchanger.

The patent US2012222424 discloses a cylinder-driven system for gas compression and expansion. The heat is transferred from the compressed or expanded gas directly to a liquid, using horizontal trays. This system is also complex and expensive.

A process was disclosed in which gas is compressed using a “liquid piston” (J. D. van de Ven and P. Y. Li, Applied Energy, 86, pp. 2183-2191, 2009). In that case, a pump is pumping a liquid to a vertical cylinder partially filled with liquid and gas. The rising liquid is compressing the gas. The heat, produced by the gas compression, is removed from the gas using internals placed in the vertical tube in order to absorb the heat and to transfer it to the liquid. The same unit is used also for the expansion of a compressed gas, working in reverse. The use of a vertical cylinder has the following disadvantages (as noted in the US Patent Appl. #20110204064): low energy density, high cost, and low efficiency. The main reason for these disadvantages is the small heat transfer area between the gas and the liquid in the vertical column.

Since both the retention time of the compressed gas and/or the heat exchange surface in the above mentioned compressors are small, the heat exchange rates are low, which leads to significant deviations from the true isothermal process, and therefore, to low isothermal efficiency.

The same reasoning is valid for the reverse process of gas compression—the gas expansion. The gas temperature decreases significantly during the expansion process due to the low heat transfer rate with the surroundings in the currently known gas expanders, resulting from both the small gas retention time and the small heat exchange surface area in the expansion volume.

Accordingly it would be advantageous to provide a novel gas compression and/or expansion system which has a large heat transfer area, long heat transfer time, and as a result, a high heat exchange rate.

### SUMMARY

The present disclosure is related to a method of pseudo-isothermal energy conversion between mechanical and pneumatic energy comprising the steps of:

providing a gas/liquid unit wherein the gas/liquid unit may be a compression unit filled with gas and a liquid storage unit containing liquid, the compression unit having thermally conductive walls;

compressing the gas by pumping the liquid into the compression unit via a liquid pump and producing compressed gas;

concurrently transferring the heat created during the compression step through the walls of the compression unit; and

transferring the compressed gas into a compressed gas storage unit and thereby storing energy in the form of pneumatic energy of a compressed gas.

The method may further include the step of filling the gas/liquid unit with gas and then repeating the compression steps.

The heat may be transferred to one of another gas or another liquid located outside of the compression unit. Alternatively, the heat may be transferred to a heat sink liquid located outside of the compression unit and the heat-sink liquid may be used for one of industrial purpose and domestic purpose.

In the gas transferring step, gas may be transferred to the gas storage unit when it reaches a predetermined pressure and transferring stops when a liquid level in the compression unit reaches a predetermined level. The predetermined pressure may be the pressure in the gas storage unit.

There may be a valve between the compression unit and the gas storage unit and the predetermined level may be proximate to the location of the valve.

The compression unit may be made of a plurality of vessels. Each vessel may have a shape that may be one of a tube, sphere and ovoid. The shape may be a tube and the tube may be one of cylindrical and tapered. The plurality of vessels may be arranged in one of parallel flow communication, series or a combination of both. The plurality of vessels may be arranged in parallel flow communication and be of the same size. The compression unit may include a plurality of vessels arranged in series and the diameter of the vessels decreases as they approach the gas storage unit. The compression unit may be positioned at an angle related to a horizontal plane. The angle may be between 0 and 90 degrees, or between 1 to 20 degrees, or between 1 to 5 degrees.

The liquid storage unit may be a second compression unit.

In the liquid filling step the compression unit may be filled by gravity from a liquid storage unit located above the compression/expansion unit. Alternatively, in the liquid filling step, the compression unit may be filled by increasing the pressure of the liquid in the liquid storage unit with compressed air and pushing the liquid into the compression/expansion unit. Alternatively, in the liquid filling step, the compression unit may be filled by pumping liquid from the liquid storage unit into the compression/expansion unit.

The method further includes steps for pseudo-isothermal expansion of gases and wherein gas/liquid unit may be a compression/expansion unit and the method further includes expansion of gases including the steps of:

transferring compressed gas from the compressed gas storage unit into the compression/expansion unit which may be initially filled with liquid, and pushing out an equal volume of the liquid from the compression/expansion unit;

allowing the compressed gas to expand thereby pushing liquid from the compression/expansion unit into the liquid storage unit via a liquid engine thereby transforming stored pneumatic energy in the form of compressed gas into mechanical energy;

concurrently heat consumed during the gas expansion step may be transferred through the walls of the compression/expansion unit; and

filling the compression/expansion unit with liquid.

The expansion of gases steps may be repeated.

The disclosure also relates to a method of pseudo-isothermal expansion of gases comprising the steps of:

transferring compressed gas from a compressed gas storage unit into an expansion unit and pushing out a portion of the liquid in the expansion unit;

the expansion unit having thermally conductive walls;

allowing the compressed gas to expand thereby pushing liquid in the expansion unit into the liquid storage unit via a liquid engine thereby transforming stored energy in the form of compressed gas into mechanical energy; and

concurrently heat consumed during the gas expansion step may be transferred through the walls of the expansion unit.

The method may further include the step of filling the expansion unit with liquid and repeating the steps.

The heat may be transferred from one of another gas or another liquid located outside of the expansion unit. The heat may be transferred from a heat providing liquid located outside of the expansion unit and the heat-providing liquid may be from for one of industrial purpose and domestic purpose. Heat for the heat-providing liquid may be from one of thermal solar collector, hydrothermal heat, industrial waste heat, and fuel.

The expansion unit may be made of a plurality of vessels. Each vessel has a shape that may be one of a tube, sphere and ovoid. The shape may be a tube and the tube may be one of cylindrical and tapered. The plurality of vessels may be arranged in one of parallel flow communication, series or a combination of both. The expansion unit may include a plurality of vessels arranged in parallel flow communication and of the same size. The expansion unit may include a plurality of vessels arranged in series and the diameter of the vessels decreases as they approach the gas storage unit. The expansion unit may be positioned at an angle related to the horizontal plane. The angle may be between 0 and 90 degrees, or between 1 to 20 degrees, or between 1 to 5 degrees.

The liquid storage unit may be a second expansion unit.

The present disclosure also includes an apparatus for pseudo-isothermal energy conversion of compressed gases comprising: a gas/liquid unit being filled with one of liquid, gas and a combination thereof, the gas/liquid unit having thermally conductive walls; a liquid storage unit in flow communication with the gas/liquid unit; a device between the liquid storage unit and the gas/liquid unit, wherein the device may be one of a liquid pump, a liquid engine and a combined pump/engine; a gas storage unit in flow communication with the gas/liquid unit; wherein when liquid may be pumped into the gas/liquid unit mechanical energy may be converted to pneumatic energy and stored in the form of compressed gas and heat may be produced and transferred through the thermally conductive walls and when the compressed gas may be expanded the pneumatic energy may be converted into mechanical energy and heat may be consumed through the thermally conductive walls.

The heat may be transferrable to one of another gas or another liquid located outside of the gas/liquid unit.

The apparatus may further include a check valve between the gas/liquid unit and the gas storage unit and a sensor that determines a predetermined level of a liquid in the gas/liquid unit.

The gas/liquid unit may be made of a plurality of vessels. Each vessel may have a shape that may be one of a tube, sphere and ovoid. The shape may be a tube and the tube may be one of cylindrical and tapered. The plurality of vessels may be arranged in one of parallel flow communication, series or a combination of both.

The gas/liquid unit may include a plurality of vessels arranged in parallel flow communication and of the same size. The gas/liquid unit includes a plurality of vessels arranged in series and the diameter of the vessels decreases as they approach the gas storage unit. The gas/liquid unit may be positioned at an angle related to the horizontal plane. The angle may be between 0 and 90 degrees, or between 1 to 20 degrees, or between 1 to 5 degrees.

The liquid storage unit may be a second gas/liquid unit.

The apparatus may include a liquid pump between the gas/liquid unit and the liquid storage unit. The apparatus may include a liquid engine between the gas/liquid unit and the liquid storage unit. The apparatus may include a combination liquid pump/engine between the gas/liquid unit and the liquid storage unit.

Further features will be described or will become apparent in the course of the following detailed description.

### BRIEF DESCRIPTION OF THE DRAWINGS

The embodiments will now be described by way of example only, with reference to the accompanying drawings, in which:

FIG. 1 is an ideal temperature-entropy diagram of the proposed method, wherein S is entropy and T is temperature;

FIG. 2 is a schematic diagram of a compression system;

FIG. 3 is a schematic diagram of an expansion system;

FIG. 4 is a schematic diagram of a combined compression and expansion system;

FIG. 5 is a schematic diagram of a compression system similar to that shown in FIG. 1 but showing two compression units;

FIG. 6 is a schematic diagram of a compression system similar to that shown in FIG. 5 but showing a single liquid pump

FIG. 7 is a schematic diagram of an expansion system similar to that shown in FIG. 3 but showing two expansion units;

FIG. 7a a schematic diagram of an expansion system similar to that shown in FIG. 7 but showing a reversible liquid engine;

FIG. 8 is a schematic diagram of a combined compression and expansion system but showing two combined compression and expansion units;

FIG. 9 is a schematic diagram of a compression unit showing three alternatives at A—vertical, B—horizontal and C—angled;

FIG. 10 is a schematic diagram of an expansion unit showing three alternatives at A—vertical, B—horizontal and C—angled;

FIG. 11 is a schematic diagram of a compression and/or expansion unit similar to that shown in FIGS. 9 and 10 but showing a plurality of parallel tubes with A—showing a top view and B—showing a side view;

FIG. 12 is a schematic diagram of a compression and/or expansion unit similar to that shown in FIG. 11A but showing the unit in an enclosure;

FIG. 13 is a schematic diagram of a compression system similar to that shown in FIG. 2 but showing a plurality of compression units;

FIG. 14 is a schematic diagram of an expansion system similar to that shown in FIG. 3 but showing a plurality of expansion units;

FIG. 15 is a schematic diagram of a compression system similar to that shown in FIG. 13 but showing a liquid pump between the compression units;

FIG. 16 is a schematic diagram of a side view of the plurality of compression and/or expansion units of FIG. 13 or 14;

FIG. 17 is a schematic diagram of a side view of the plurality of compression units of FIG. 17 and showing an intermediate liquid pump;

FIG. 18 is a schematic diagram of a side view of the plurality of expansion units of FIG. 16 and showing an intermediate liquid engine;

FIG. 19 are perspective view of alternate heat transfer surfaces including plates A, fins B and D, and fingers C;

FIG. 20 is a schematic diagram of pneumatic cylinders used as liquid pump and/or engine.

FIG. 21 show views of different shapes of vessels that may be used for the compression and/or expansion vessels including spherical A, ovoid B, cylindrical tube C or tapered tube D.

### DETAILED DESCRIPTION

The embodiments described herein are based on:
1) The separation in space of the mechanical energy input, from one side, and the simultaneous gas compression and heat exchange, from the other side;
2) The separation in space of the mechanical energy removal, from one side, and the simultaneous gas expansion and heat exchange, from the other side;
3) During the process of compression, providing a very large heat transfer area and a high heat transfer conductivity between:
   a. The compressing gas and the liquid which compresses the gas;
   b. The compressing gas and the internal walls of the compression unit and further from the external walls of the compression unit to the heat-sink (cooling) fluid;
   c. The liquid which compresses the gas and the internal walls of the compression unit and further from the external walls of the compression unit to the heat-sink fluid;
   d. In the cases when the heat transfer from the liquid through the walls of the compression unit is not sufficient to maintain isothermal conditions, an external heat exchanger can be used to additionally cool the liquid.
4) During the process of expansion, providing a very large heat transfer area between:
   a. The expanding gas and the liquid being moved by the expanding gas;
   b. The expanding gas and the internal walls of the expansion unit and further from the external walls of the expansion unit to the heat-providing (heating) fluid;
   c. The liquid being moved by the expanding gas and the internal walls of the expansion unit and further from the external walls of the expansion unit to the heat-providing fluid.
   d. In the cases when the heat transfer to the liquid through the walls of the expansion unit is not sufficient to maintain isothermal conditions, an external heat exchanger can be used to additionally heat the liquid.

When the described embodiments are used for gas compression, the mechanical energy is supplied to the system by a liquid pump and is transferred to a separate compression unit by liquid flow. The processes of gas compression and heat exchange are taking place simultaneously in the compression unit. The system contains inexpensive gas compression unit which has large heat exchange area, high heat conductivity and low shear stress to the moving liquid and gas. Both the heat exchange area and the gas retention time can be easily and independently varied. Since the efficiency of liquid pumps (up to 97%) is usually higher than that of gas compressors, and since the heat exchange rate is very high in the proposed system, the overall isothermal compression and expansion efficiencies in the proposed system can be very high, reaching 70-90% and even higher. At the same time, the cost to build and operate the proposed system for gas compression and/or expansion can be much lower than that to build and operate most of the currently known compression/expansion systems.

When the described embodiments are used for gas expansion, the expanding gas is introduced from a compressed gas storage vessel or unit to a gas expansion unit filled with liquid. The processes of gas expansion and heat exchange are taking place simultaneously in the expansion unit. The mechanical energy of the gas expansion is transferred, using liquid flow, to a separate mechanical device. In the mechanical device the energy of liquid flow is converted to mechanical energy. That mechanical device is referred to in this document as “liquid engine”. The same type of device is named “hydraulic motor” in the hydraulic field. The liquid engine is the reverse of a liquid pump and can be represented by units known in the engineering practice such as these of dynamic (turbo) or a positive displacement type.

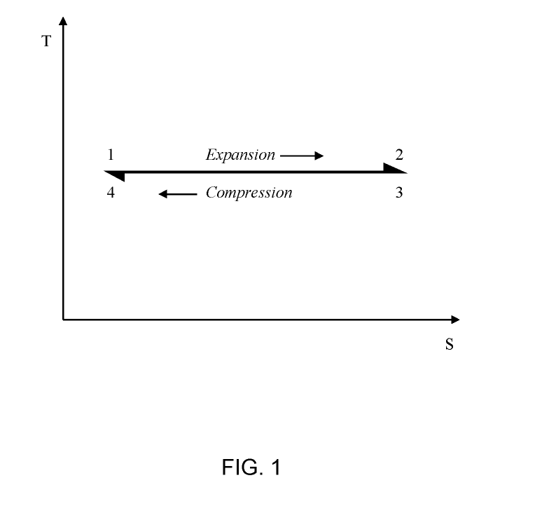

The proposed system for gas compression and/or expansion has large heat exchange area and provides large gas retention time at low fluid friction, and as a result has a very high isothermal efficiency. It can be built from low cost elements. The ideal temperature-entropy diagram of the proposed isothermal CAES cycle is shown in FIG. 1. When used for the isothermal compressed air energy storage, the proposed devise is referred to as ItCAES.

Generally speaking, the embodiments described herein are directed to a system for pseudo isothermal compression and/or for pseudo isothermal expansion of gases. As required, the described embodiments are disclosed herein. However, the disclosed embodiments are merely exemplary, and it should be understood that there may be many various and alternative forms. Some features may be exaggerated or minimized to show details of particular elements while related elements may have been eliminated to prevent obscuring novel aspects.

There is disclosed herein a method and apparatus to compress or to expand gases in a very close to true (theoretical) isothermal manner.

The described embodiments can be used for the compression and/or expansion of different gases using different liquids as an intermediate for the mechanical energy transfer. However, for the sake of simplicity, in the descriptions below, the gas is assumed to be air and the liquid is assumed to be water. The gas can be compressed starting from different initial pressures lower than the final pressure. However, for the sake of simplicity, in the descriptions below it is assumed that the initial pressure of the compressing gas is atmospheric. Also, a gas can be expanded to any pressure lower than the initial one. However, for the sake of simplicity, in the descriptions below, it is assumed that the final gas pressure at the end of the expansion process is atmospheric one, and the gas pressure in the gas storage unit is higher than atmospheric.

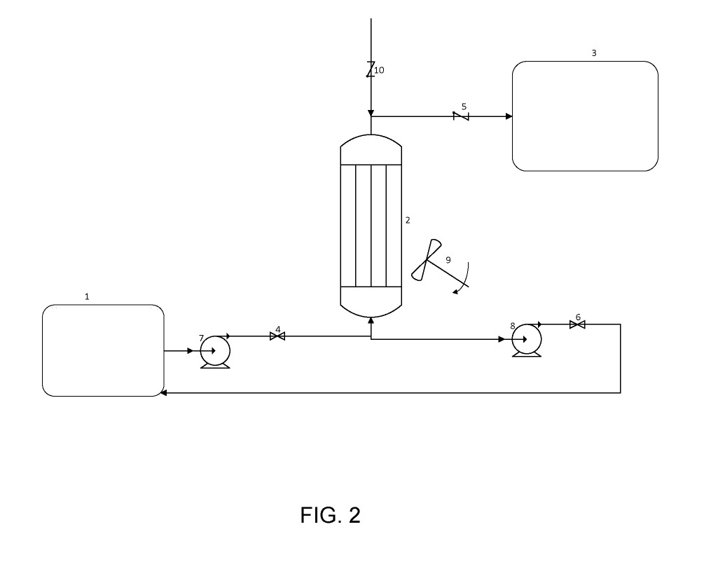

FIG. 2 shows an embodiment of the proposed system for the compression of gases. The valve 10 allows the flow of air only into the compression unit 2. It can be a check valve or a controllable one.

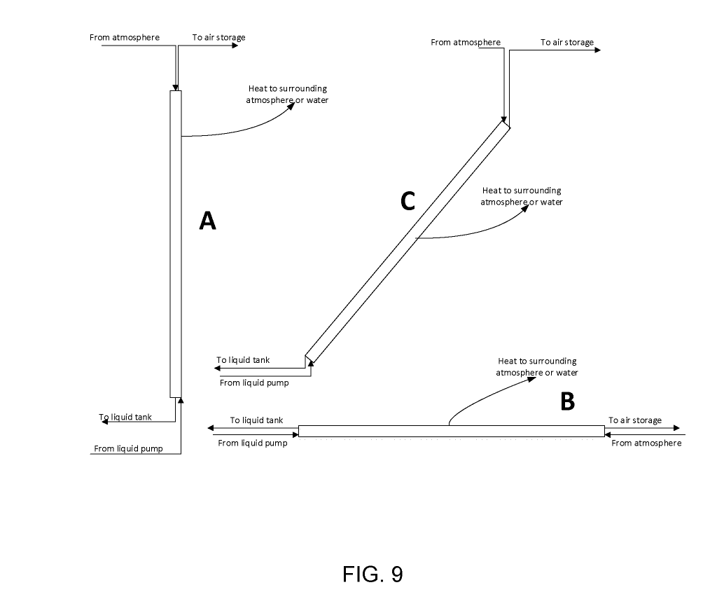

The compression unit 2 also acts as a heat exchanger between the compressing gas and external air or water. Different heat exchanging devices and modes are shown in FIGS. 9-18.

Initially, the compression unit 2 is filled with air at atmospheric pressure. Valve 6 is closed, water pump 8 is turned off and water pump 7 is turned on and valve 4 is opened thus filling the compression unit with water. The water filling the compression unit 2 compresses the air in it. The heat released during the gas compression is removed from the compression unit via heat exchange to the surrounding air or water through either directly through the walls of the compression unit or first to the compressing liquid and then to the wall of the compression unit. The walls of the compression unit are thermally conductive. The heat transfer is shown schematically in FIG. 9. The rate of filling the compression unit with water (and therefore, the compression rate and the rate of heat release by the compressed gas) is chosen so that the temperature of the compressing gas is raised by a reasonable value, for example by not more than 20° C. above the temperature of the cooling (heat sink) fluid. As an example, the cooling fluid can be ambient air. As soon as the pressure of the compressed air reaches the pressure in the air storage vessel or unit 3, the check valve 5 opens. The check valve 5 allows air to flow only in the direction towards the air storage vessel or unit 3. As soon as liquid pushes all the air from the compression unit 2 to the air storage vessel or unit 3 preferably reaching the check valve 5, the liquid pump 7 is stopped, the valve 4 is closed, the valve 6 is opened and the liquid pump 8 is turned on. Thus, liquid leaves the compression unit 2 towards the liquid storage vessel or unit 1 and is replaced by a gas for compression via check valve 10. A pump 8 may be installed to accelerate liquid flow and/or counter the hydrostatic pressure of the liquid filling the vessel or unit 1. The vessel or unit 1 may be open to the atmosphere. When most or all of the liquid leaves the compression unit, valve 6 is closed and the cycle repeats. The cycles repeat until the gas storage vessel 3 is filled with air at the required pressure.

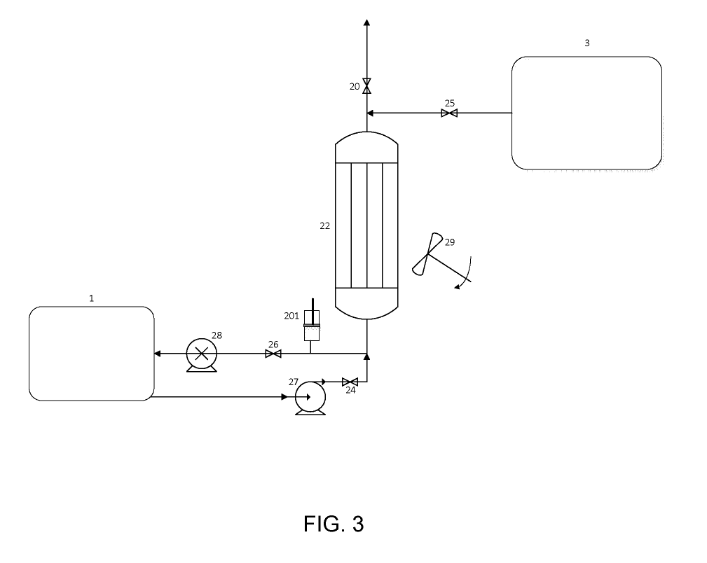

FIG. 3 shows the use of the proposed system for gas expansion. The compressed gas storage vessel 3 contains air at pressure higher than the final one (the pressure after expansion). As an example, the final pressure may be close to the pressure of the ambient air. Initially, the expansion unit 22 is filled with water from the water tank 1 using the liquid pump 27, expelling the air from the expansion unit 22 through the opened valve 20. During the filling of the expansion unit with water, the pump 27 is on and the valve 24 is opened, while the valve 26 is closed and valve 20 is opened. Alternatively, if the water tank 1 is located above the expansion unit, the latter can be filled by the hydrostatic pressure, without using a pump 27. Once the expansion unit is completely or nearly completely filled with water, valves 24 and 20 are closed and pump 27 is turned off. Preferably, the expansion unit should be filled completely with water, up to the valve 25. Then, the control valve 25 is briefly opened and certain amount of compressed air is allowed to replace water in the expansion unit 22. Alternatively, a volume control unit 201 which may be a reciprocating piston, may be used to control precisely the volume of the compressed gas introduced to the expansion unit 22. The same compressed gas volume control can be used in any of the expansion units described in this document. During the compressed gas introduction to the expansion unit, liquid having the volume equal to that of the compressed gas, introduced to the expansion unit, is removed via valve 26 or fills the unit 201. The volume of the compressed air to enter the expansion unit can be estimated approximately from the relationship:

V_{comp.air}≦P_{final}·Vₑₓₚ/P_{storage} (1)

where V_{comp.air} is the volume of compressed air introduced to the expansion unit 22, Vₑₓₚ is the total volume of the expansion unit, P_{storage} is the pressure of air in compressed air storage vessel 3, P_{final} is the pressure in the expansion unit at the end of the expansion cycle. The volume of the introduced pressurized air can be measured either from the amount of water displaced from the expansion vessel or directly from the volume of the compressed gas introduced to the gas expansion unit. After the compressed air with the pre-determined volume is introduced to the expansion unit 22, valve 25 is closed and valve 26 is opened. The water flowing from the expansion unit 22 to the liquid storage vessel 1 passes through the liquid engine 28, producing mechanical energy. Once the pressure in the expansion unit reaches its final pressure (at that time, most or all of the water in the expansion unit 22 is transferred to the liquid storage vessel 1), valve 26 is closed, valve 24 is opened, the liquid pump 27 is turned on and the expansion unit 22 is filled with water. The cycle repeats.

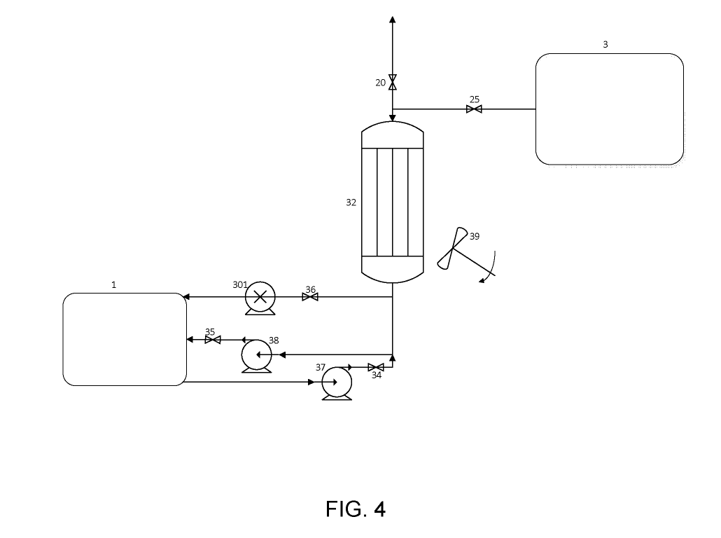

FIG. 4 shows an embodiment of the system where both the compression and the expansion of the gas are performed in the same compression/expansion unit 32. During the compression period the system operates according to the description to FIG. 2. During the expansion period, the system operates according to the description to FIG. 3. This embodiment includes a pump 37 which performs the same function as pump 7 and pump 27; a valve 34 which performs the same function as vale 24 and valve 4, a pump 38 which performs the same function as pump 8; a valve 35 which performs the same function as valve 6; a liquid engine 301 which perform the same function as liquid engine 28; and a valve 36 which performs the same function as valve 26.

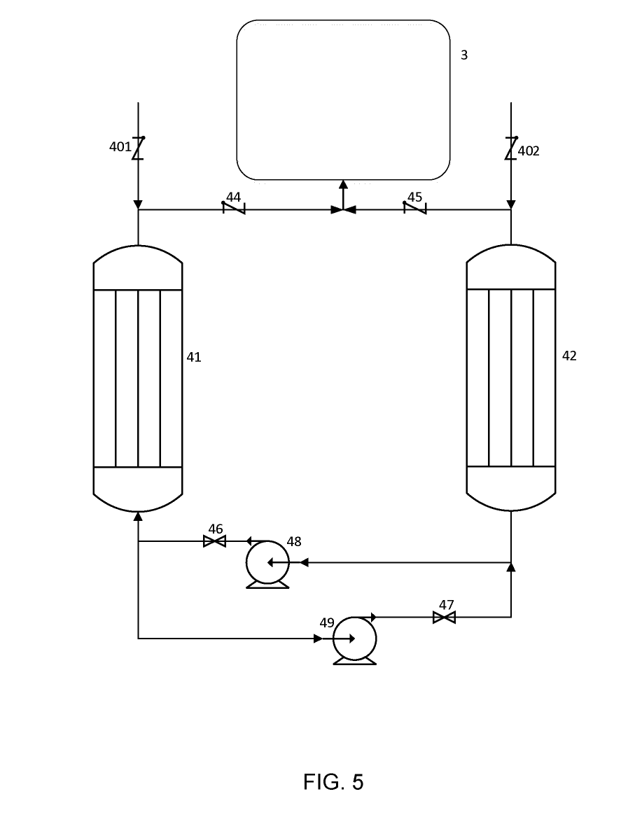

FIG. 5 shows the embodiment of a compression system where the liquid storage vessel 1 in FIG. 2 is replaced by a second compression unit 41. The volumes of compression units 41 and 42 are close to each other. The total volume of water is close or slightly larger than the volume of each of the compression units 41 and 42. Initially the compression unit 41 is filled with water and the compression unit 42 is filled with air. The valve 44 is closed and the valve 45 is opened. The valve 47 is opened and the pump 49 is turned on. As a result, water starts filling the compression unit 42. The check valve 401 opens to replace the water leaving the compression unit 41 with air while the check valve 402 closes. As soon as the pressure in the compression unit 42 exceeds the pressure in the compressed air storage vessel 3, the check valve 45 opens and compressed gas starts filling the gas storage unit. As soon as water completely fills the compression unit 42, preferably up to the valve 45, the pump 49 is turned off and the valve 47 and the check valve 45 are closed. Following that, the pump 48 is turned on and the valve 46 is opened. As a result, the compression unit 41 starts filling with water. The check valve 402 opens while the check valve 401 closes. As soon as the pressure in the compression unit 41 exceeds the pressure in the storage vessel 3, the check valve 44 opens and compressed gas starts filling the gas storage unit 3. As soon as water fills the compression unit 41, preferably up to the valve 44, the pump 48 is turned off and the valve 46 and the check valve 44 are closed. After that point, the cycle repeats.

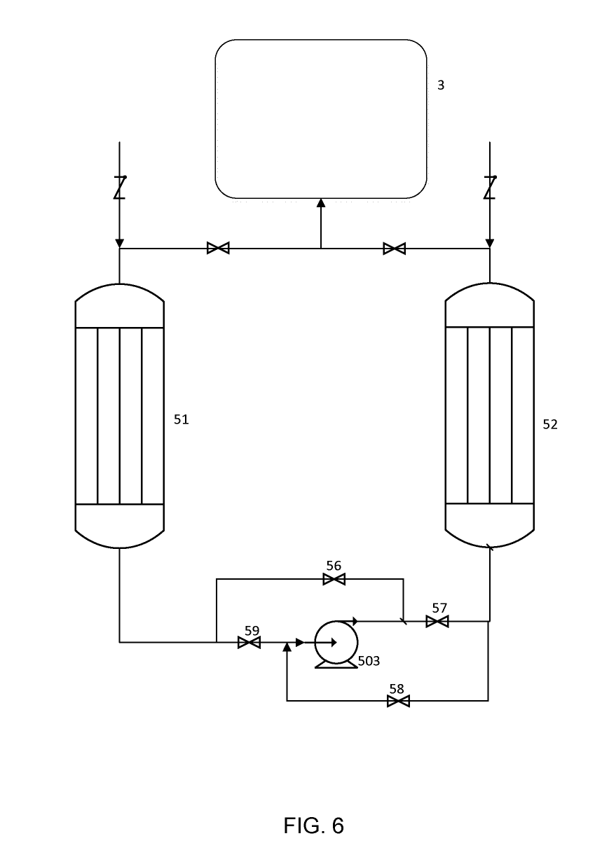

FIG. 6 shows an embodiment similar to that in FIG. 5, but using only one liquid pump 503. In order to pump water from compression vessel 51 to compression vessel 52, valves 56 and 58 are closed, while valves 57 and 59 are opened. In order to pump water in the opposite direction, from compression unit 52 to compression unit 51 valves 57 and 59 are closed and valves 56 and 58 are open.

The reverse of the flow using a single pump can be achieved also by other means known in the practice, for example by using a reversible pump, able to pump liquid back or forward.

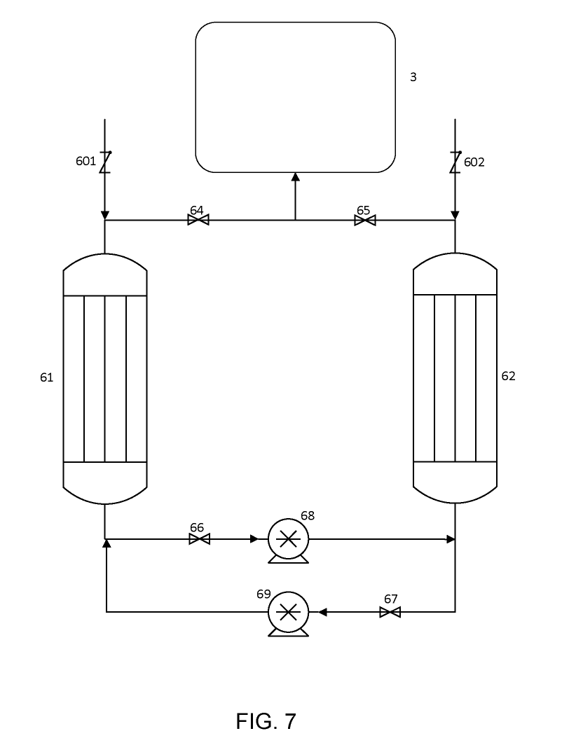

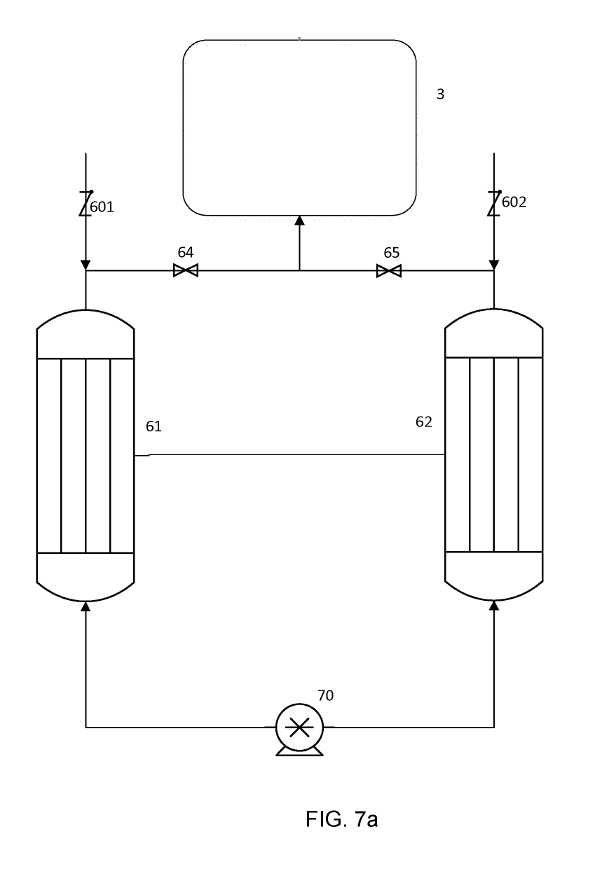

FIG. 7 shows an embodiment of the proposed system with two expansion units connected together. The compressed gas storage vessel 63 contains air at pressure higher than the atmospheric one. Initially, the expansion unit 61 is filled with water completely. At that time the valves 64, 65, 601, 66 and 67 are closed and valve 602 is open. Then, the control valves 64 and 66 are briefly opened and certain amount of compressed air is allowed to replace water in the expansion unit. The volume of the compressed air to enter the expansion unit can be estimated approximately from the relationship:

V_{comp.air}≦P_{final}·Vₑₓₚ/P_{storage}+P_{hydrostatic} (2)

where V_{comp.air} is the volume of compressed air introduced to the expansion unit 61, Vₑₓₚ is the total volume of the expansion unit 61, P_{storage} is the pressure of air in its storage unit 63 in atmospheres, and P_{hydrostatic} is the hydrostatic pressure required to completely empty the expansion unit 61 into the expansion unit 62. The volume of the introduced pressurized air can be measured either from the amount of water displaced from the expansion unit or directly from the volume of the compressed gas in the gas expansion unit. Alternatively, the liquid removal device 201, shown in FIG. 2, may be used to precisely control the volume of the compressed air introduced to the expansion unit 61. After the compressed air with the pre-determined volume is introduced to the expansion unit 61, valve 64 is closed and valve 66 is opened. The water flowing from the expansion unit 61 to the expansion unit 62 passes through the valve 66 and the liquid engine 68, producing mechanical energy. Once most of the liquid in the expansion unit 61 is transferred to the expansion unit 62, valve 66 is closed. At that time valve 601 is opened and valve 602 is closed. Valves 65 and 67 are briefly opened in order to allow a volume of compressed air, as calculated from Eq. 2, to enter the expansion unit 62. Then valve 65 is closed. The water flowing from the expansion unit 62 to the expansion unit 61 passes through the valve 67 and the liquid engine 69, producing mechanical energy. Once all the liquid in the expansion unit 62 is transferred to the expansion unit 61, valve 67 is closed. The cycle repeats.

The liquid engines 69 and 68 may be replaced by a single, reversible liquid engine 70 (FIG. 7a). The reversible liquid engine must be able to operate as a liquid engine both forward and backward. Also, a single non-reversible liquid engine can be used to operate in both directions by using a set of valves as described in FIG. 6.

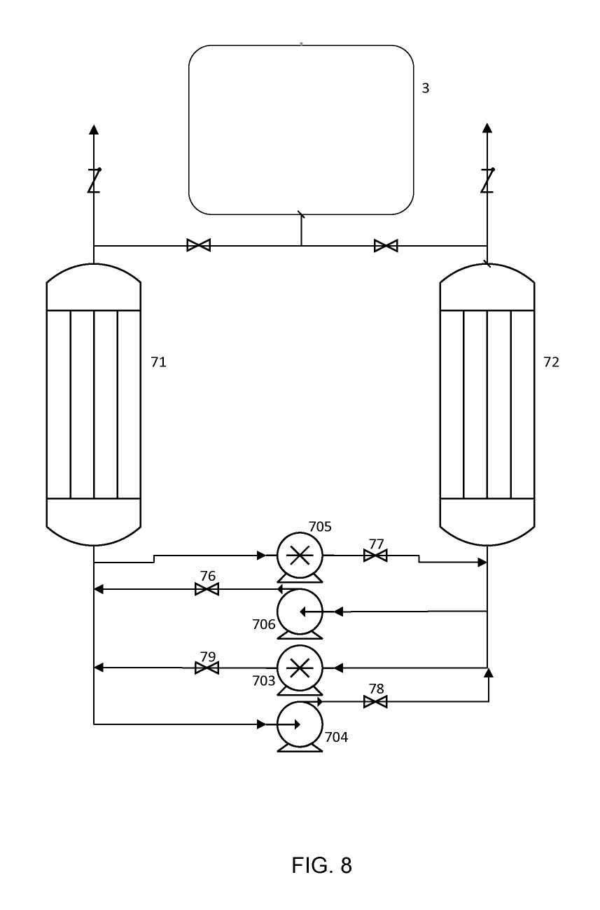

FIG. 8 shows another embodiment in which a pair of compression/expansion units 71 and 72 are used each as both expansion units and compression units. This embodiment is very useful for such applications as CAES systems where the gas is first compressed and later expanded. During the period when the entire system acts as a compressor, the pumps 706 and 704 are engaged consecutively as described in FIG. 5. Valves 77 and 79 are closed at that stage. Once the air is compressed and stored in the compressed gas storage unit 73, mechanical energy can be obtained from the system by expanding the compressed air using the liquid engines 705 and 703. Valves 76 and 78 are closed at that stage and pumps 704 and 706 are turned off. The system operates at that stage as a gas expander according to the description to FIG. 7. The compression and expansion periods can be repeated many times.

The set of pumps (704 and 706) and of liquid engines (703 and 705) shown in FIG. 8 is exemplary, and can be replaced by other ways to irreversibly or reversibly pump liquid and irreversibly or reversibly obtain mechanical energy from flowing liquid. For example, pumps 704 and 706 can be replaced by a single reversible pump. Similarly, the liquid engines 703 and 705 can be replaced by a reversible liquid engine. Also, the combination of a pump and a liquid engine (either the set of 705 and 706, or the set of 703 and 704, or both sets) can be replaced by a liquid pump/engine unit. Also, both the pumps plus both the liquid engines (703, 704, 705 and 706) can be replaced by a single reversible liquid pump/engine that can pump liquid backwards and forward, and also can act as a liquid engine both backwards and forward.

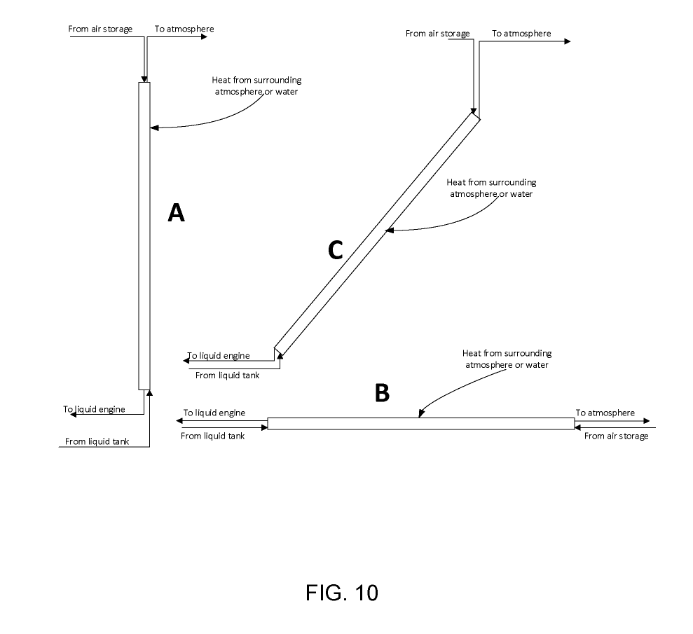

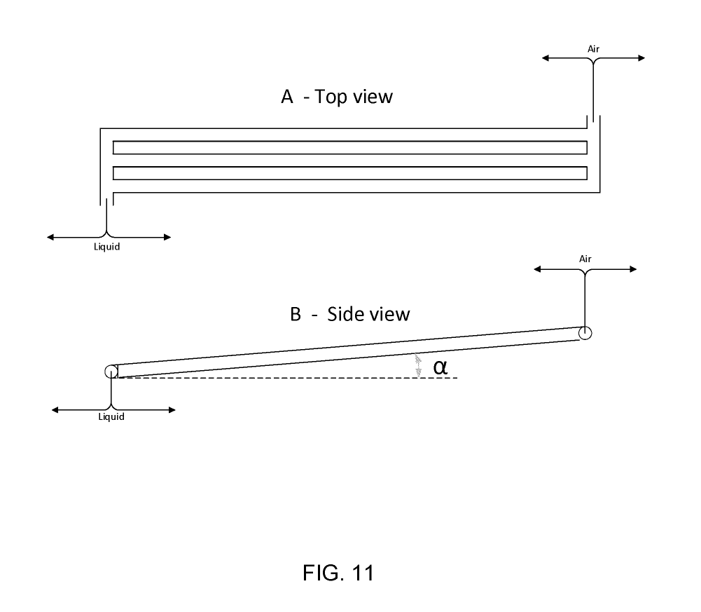

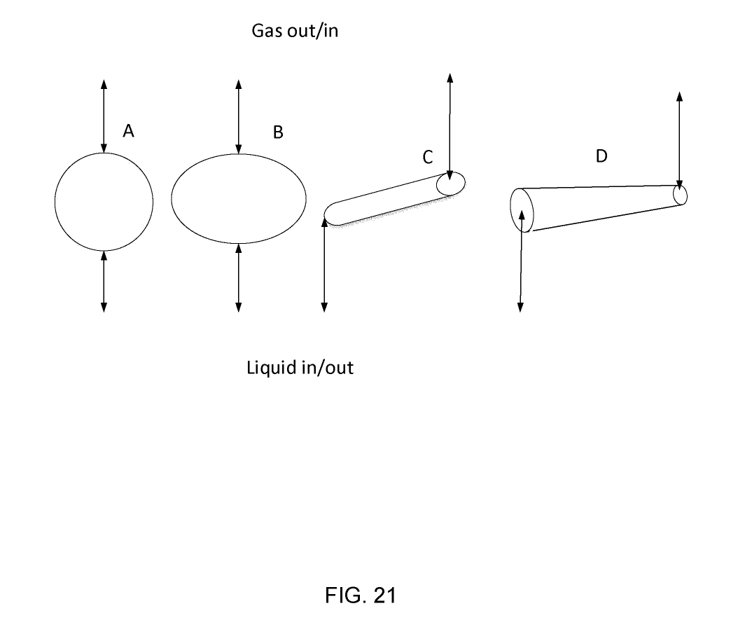

The following FIGS. 9-18 deal with the different designs of the compression and/or expansion units acting also as heat exchangers. Each of the designs described below can be used as the compression and/or expansion units described in FIGS. 2-8. While the expansion and compression units can have any shape (FIG. 21 A-D), advantageous is spherical, and even more advantageous, tubular shape (FIGS. 9-12, 16 and 21 C, D). The tubular shape can be cylindrical or tapered (FIG. 21 C, D). It is advantageous if the upper level of the tapered tube is horizontal (FIG. 21 D). In the case of a tubular shape, the tube axis may have any shape, but it is advantageous to be straight (FIGS. 9 and 10). Each of the expansion or compression units can be represented by either a single cylinder (tube) (FIGS. 9 and 10) or a multitude of tubes (FIG. 11). The tubes can be connected in parallel or/and in series. It is advantageous in many cases the multitude of tubes to be in parallel flow communication (FIG. 11). It is advantageous if the inputs to all the parallel tubes are located on the same height. It is also advantageous if the exits of the parallel tubes are also located on the same height (FIG. 11). The expansion and/or compression tubes can be installed at any angle relatively to the horizontal plane: horizontal (0 degree—FIG. 9B, 10B), vertical (90 degrees—FIG. 9A, 10A), or in between (FIG. 9C, 10C). In the case of pressure increase (in the case of compression) or decrease (in the case of expansion) by less than 2 times, vertical or close to vertical position of the compression/expansion tube(s) is preferable (FIG. 9A, 10A). When the pressure is increased or decreased more than twice, the horizontal (FIG. 9B, 10B) or close to horizontal (FIG. 11B, at an angle α) position provides larger heat-transfer surface area between the compressing gas, the liquid in the tubes and the inner tube surface. It is advantageous to have the angle α between 0 and 10 degree, and even more advantageous between 1 and 5 degree. It is preferable to locate the gas exit of any of the compressing units at the highest point of the unit in order to avoid the formation of air pockets. It is advantageous to locate the liquid connection in any of the compression and/or expansion units at the lowest possible point in order to avoid dead zones of liquid.

When a tubular geometry of the compressor and/or expander is used, one of the important considerations is the decrease of the energy losses due to liquid friction. In general, having the same tube diameter and the same total volume, it is preferable to use a larger number of shorter tubes connected in parallel, than a smaller number of longer tubes. As an example, it is preferable to use 10 parallel tubes 50 cm long each, than one tube 500 cm long, all of the same diameter. The optimal number of tubes to tube length ratio should be determined from the cost analysis.

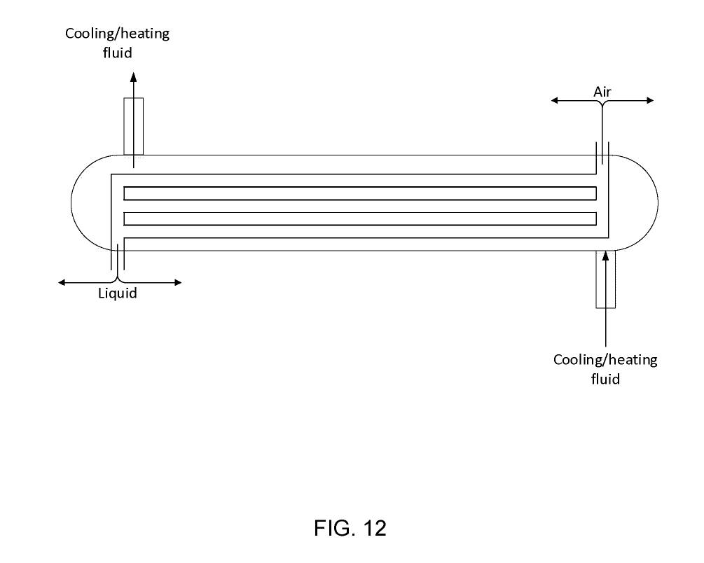

The tube(s) of the compression and/or expansion unit can be contacting directly the surrounding air or water (FIGS. 9, 10, 11, 16-18). In that case, the surrounding air or water acts as a heat sink or heat supply for the compressing or expanding gas, respectively. Alternatively, the tube(s) can be placed in an enclosure, similarly to tubular heat exchangers (FIG. 12). The cooling liquid or air (the heat sink) enters the enclosure, exchanges heat with the tube(s) of the compression/expansion unit and then leaves the enclosure (FIG. 12). Each of these heat exchange modes (FIGS. 9-18) is applicable to any of the compression and/or expansion units described herein.

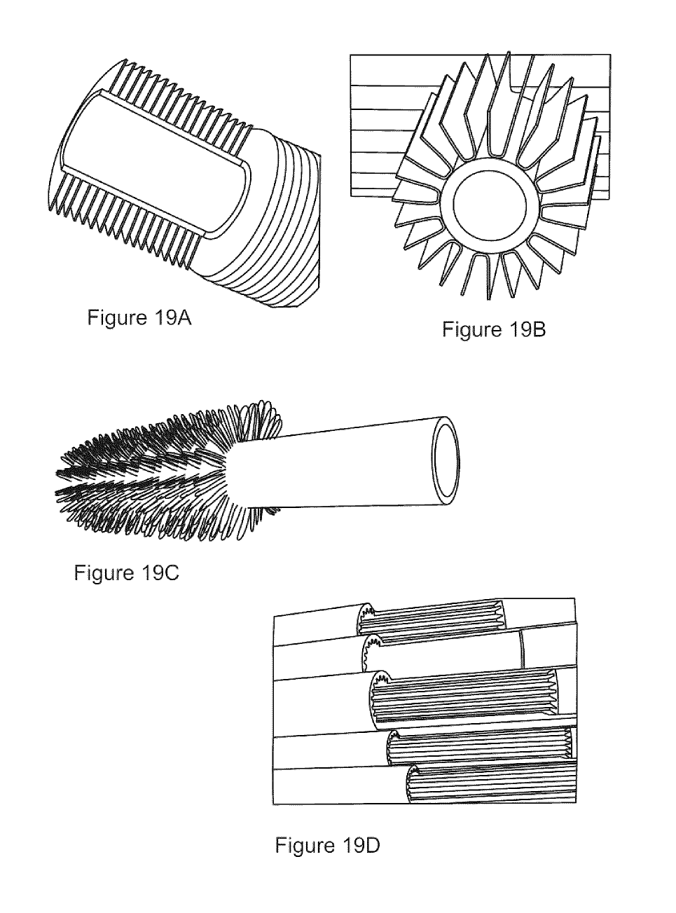

The compression and/or expansion unit may have bare walls. Alternatively, heat transfer extended surfaces such as fins (FIG. 19) may be attached to the wall of the compression and/or expansion unit either outside of the vessel (FIG. 19 A, B, C), inside the vessel (FIG. 19, D) or both inside and outside. Each of these types of heat transfer surfaces may be installed in any of the compression and/or expansion units described in any of the figures here.

The compression and/or expansion unit may be cooled by an ambient air which surrounds the compression and/or expansion unit. The flow of the ambient air around the compression unit may be either natural or may be enhanced by air moving device such as impeller 9 (FIG. 2). The compression unit may be cooled also by spraying water to the outside wall of the compression unit. Alternatively, the compression and/or expansion unit may be immersed in liquid such as water, and be cooled and/or heated by the heat transfer with the surrounding liquid.

In the above descriptions the heat is transferred between the compressing and/or expanding gas and the cooling and/or heating fluid through the external walls of the compression unit. This way of heat exchange is named here “external heat exchange”. The heat transfer between the compressing and/or expanding gas and the cooling fluid may be performed also using internal heat exchange. In that case the cooling fluid is pumped inside of heat exchange tubing placed inside of the compression and/or expansion unit. The heat exchange between the compressing and/or expanding gas and the cooling/heating fluid can be performed by either external heat exchange, internal heat exchange or by the combination of both.

The compressing or expanding gas in the compression or expansion units may contain no gas moving devices. Alternatively, in order to increase the heat transfer rate between the compressing or expanding gas and the cooling or heating fluid, the compressing of expanding gas may be moved within the compression or expansion unit using a fan or other method for gas movement. The gas moving device may be placed inside of the compression or expansion unit. Alternatively, the gas moving device may be placed outside of the compression or expansion unit, and is in flow communication with the compressing or expanding gas.

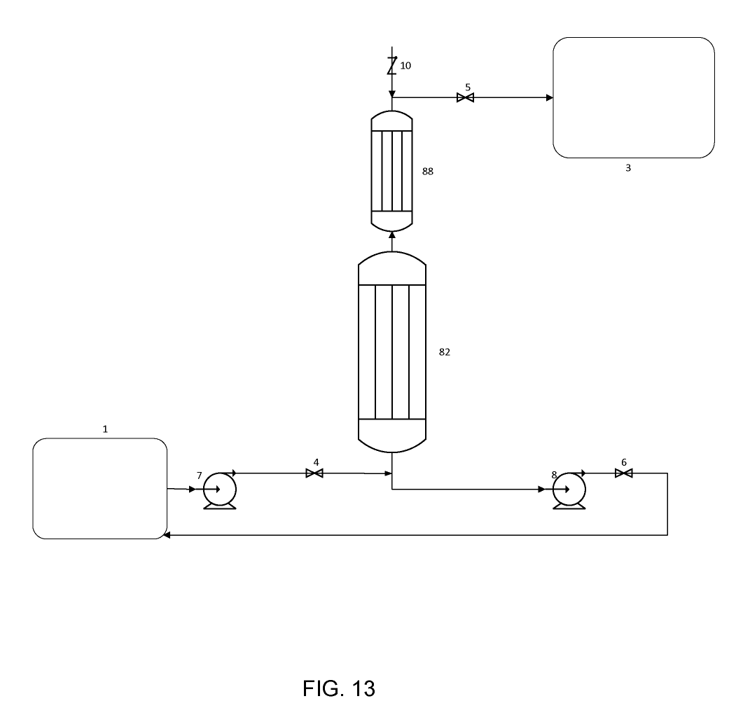

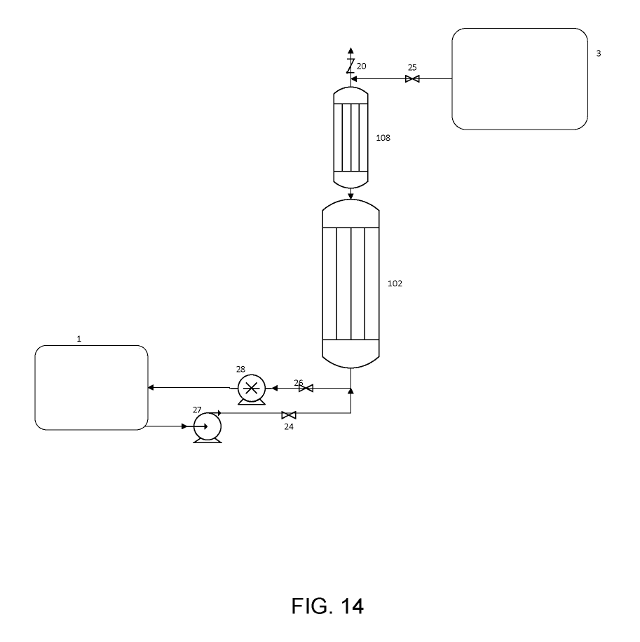

FIG. 13 shows another embodiment of the proposed system which is similar to that shown in FIG. 2 and in which each compression unit contains two or more heat transfer elements connected in series. As soon as a certain degree of compression is reached in the compression unit, it is advantageous to increase the surface-to-volume ratio of the gas compression unit since more heat will be exchanged with the surroundings per unit gas volume. In addition, using smaller diameter tubes at higher pressures allows the use of smaller tube wall thickness, which improves the heat transfer through the tube wall. Since the surface-to-volume ratio of cylindrical and spherical units is inversely proportional to the diameter of the cylinder or the sphere, the use one smaller diameter compression element or of a multitude of smaller diameter parallel elements will provide larger surface area per unit volume. In the example of cylindrical geometry of the compression unit, a second stage compression unit 88 is attached to the exit of the first stage compression unit 82. Each the first and the second stage compression unit can be represented by a single tube or a multitude of parallel tubes. While FIG. 13 shows only two compression units in series, their number can be more than two. Normally, the volume of the next compression unit should be smaller than that in the previous one because the gas volume decreases as it is compressed. The two stage compression unit shown in FIG. 13 can be used also for the expansion of gases (FIG. 14). The expansion unit is similar to that shown in FIG. 3 but showing a first expansion unit 108 and then a second expansion unit 102. It will be appreciated that more than two expansion units may be used. Further as described above in regard to the expansion units, the size expansion units may increase towards the liquid storage unit 1.

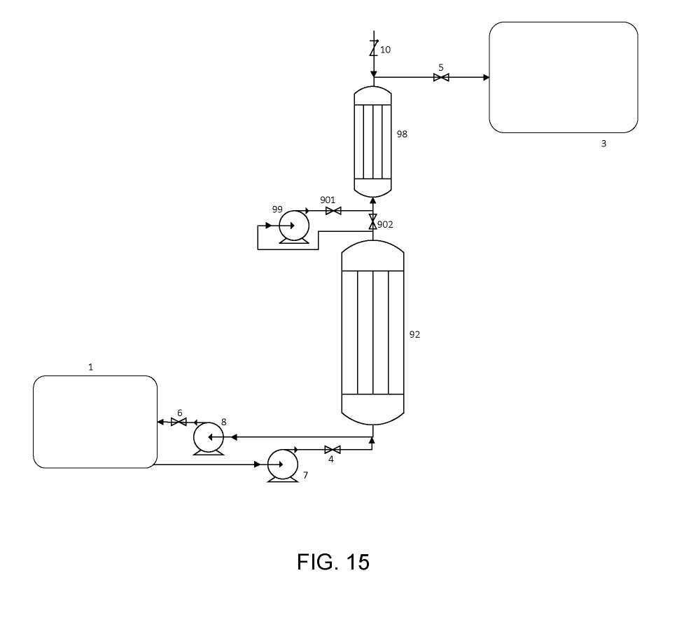

FIG. 15 is an embodiment similar to that shown in FIG. 13 but it has an additional liquid pump 99 is installed between the first (92) and second (98) compression units. This pump is advantageous in the case of higher compression ratios. While the compression liquid is only in the compression unit 92, the liquid pump 7 is on and the valve 902 is open. Under these conditions, the gas is expanded in both the expansion unit 92 and in the expansion unit 98. As soon as the liquid reaches and fills the liquid pump 99, the latter is turned on, the valve 902 is closed and the valve 901 is opened. At that time, the gas is compressed only in the compression unit 98. It should be noted that the described here embodiment can contain more than two compression units in series, some or all the pairs connected with a liquid pump. During the liquid emptying cycle, pumps 7 and 99 are turned off and the valves 10, 6 and 902 are open. The check valve 5 is closed.

Similarly, a liquid engine may be installed between the two expansion units 102 and 108 in FIG. 14.

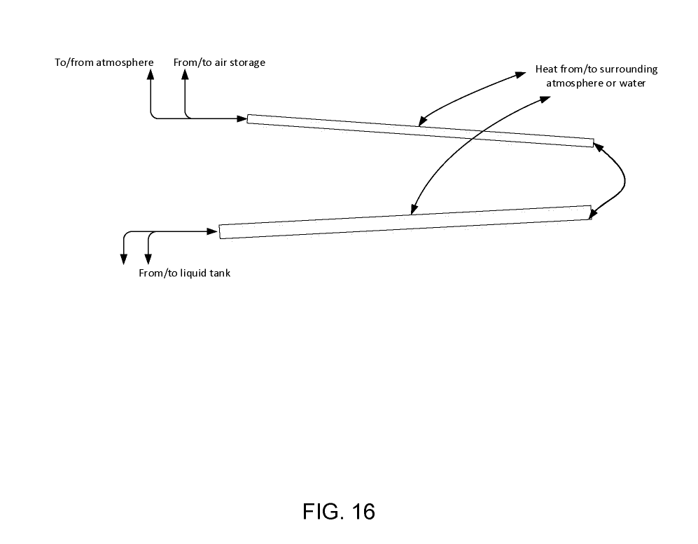

FIG. 16 shows a typical design of any of the two-stage compression and/or expansion modules shown in FIGS. 13-15, when tubular geometry is used.

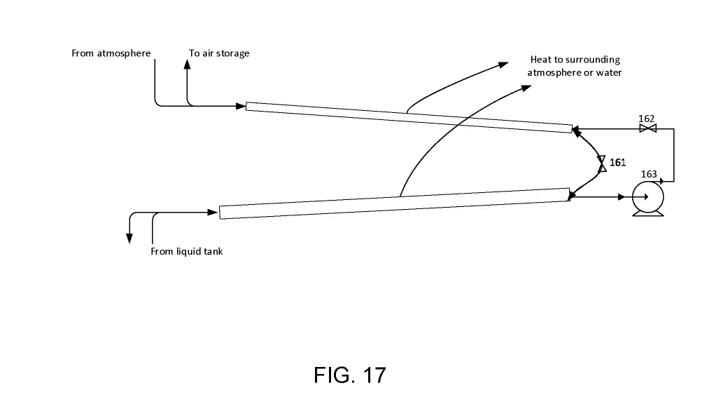

FIG. 17 shows a typical design of any of the two-stage compression module shown in FIG. 16, when intermediate pump between the two stages is used. During the compression stage, initially the valve 161 is opened, the valve 162 is closed and the pump 163 is turned off until the liquid reaches the valve 161. As soon as the liquid reaches the valve 161, it is closed, the valve 162 opens and the pump 163 is turned on. After the end of the compression cycle, the liquid leaves the compression unit through the valve 161, which is open at that stage. The valve 162 is closed and the pump 163 is turned off.

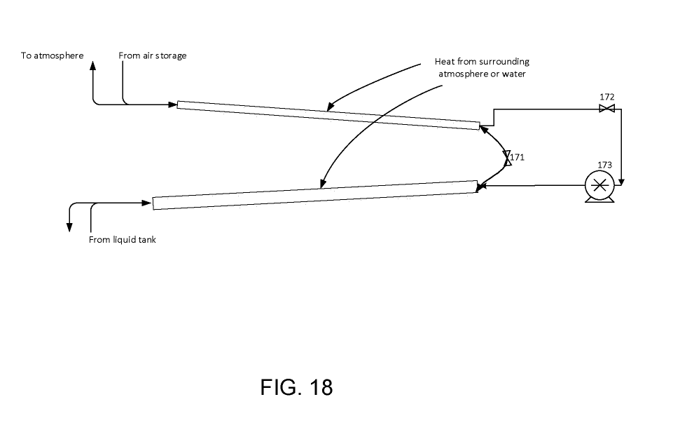

FIG. 18 shows a typical design of any of the two-stage expansion module shown in FIG. 16, when intermediate liquid engine is used between the two stages. During the expansion stage, initially the valve 171 is closed, the valve 172 is opened and the liquid engine 173 is turned on until the liquid reaches the valve 171. As soon as the liquid reaches the valve 171, it is opened, the valve 172 closes and the liquid engine 173 is turned off. After the end of the expansion cycle, the liquid fills the expansion unit through the valve 171, which is open at that stage. The valve 172 is closed and the liquid engine 173 is turned off.

Each of the modes of heat transfer described in FIGS. 9-18 and the above text is applicable to each of the compression and/or expansion units described in FIGS. 2-8 and in the rest of this document.

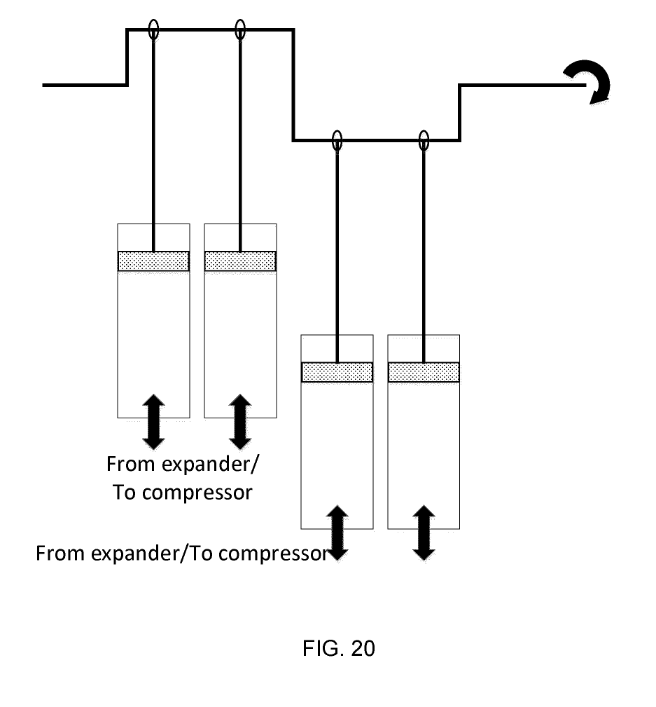

When during the compression the gas compression ratio is high, it is difficult to find a liquid pump which would operate at very high liquid flow rate and low pressure (at the beginning of each compression cycle) and very low liquid flow rate and high pressure (at the end of each cycle). In that case, two or more different pumping devices may be used at the different stages of the pumping cycle. The (high pressure)/(low flow rate) pump can be of a positive displacement type such as, but not limited to, piston or rotary vane type. The device can be one of the following, but not limited to:
A conventional gas compressor (single or multi-stage);
Using a (low pressure)/(high flow rate) liquid pump such as centrifugal one;
A tank located significantly higher than the compression unit (for example, 10 metres and higher) can supply the compression unit with liquid. In that case the tank is filled by a (low pressure)/(high flow rate) liquid pump. Alternatively, if the wind turbine is connected directly to a hydraulic pump, the vessel can be filled by that pump;
Use of a large volume hydraulic cylinder, or a set of cylinders. In order to accommodate large variations of liquid flow rates and pressure, the cylinder can be connected to a varying torque device or to a flywheel (FIG. 20). In that case, the total volume of the hydraulic cylinder(s) should be close to the volume of liquid expelled from the expansion unit or pumped to the compression unit during one cycle.

When during the expansion the gas expansion ratio is high, it is difficult to find a liquid engine which would operate at very high liquid flow rate and low pressure (at the beginning of each compression cycle) and very low liquid flow rate and high pressure (at the end of each cycle). In that case, two or more different pumping devices may be used at the different stages of the pumping cycle. The (high pressure)/(low flow rate) engine can be of a positive displacement type such as, but not limited to, piston or rotary vane type. The device can be one of the following, but not limited to:
A pneumatic (or compressed air) motor (single or multi-stage);
Using a (low pressure)/(high flow rate) liquid engine such as but not limited to Francis, Pelton or Kaplan turbine;
Use of a large volume hydraulic cylinder, or a set of cylinders. In order to accommodate large variations of liquid flow rates and pressure, the cylinder can be connected to a varying torque device or to a flywheel.

The devices described in FIGS. 2, 4, 5, 6, 8, 13 and 15, having compression units as shown in FIG. 12, can also be used to produce hot or warm water, air or another fluid. In that case the cooling of the compressing gas is performed at temperatures above the ambient temperature, for example by 5° C. to 80° C. higher. In that case the heated heat-sink liquid can be used for technological or domestic purposes outside of the ItCAES.

The devices described in FIGS. 3, 4, 7, 7a, 8 and 14, having expansion units as shown in FIG. 12, can also be used to produce cold water or other fluid. In that case the heating of the expanding gas is performed at temperatures below the ambient temperature, for example by 5° C. to 80° C. lower. In that case the cooled heat-supply liquid can be used for technological or domestic purposes outside of the ItCAES.

The proposed technology can be used also as an electrical power generator. In that case it operates in a pseudo isothermal mode, but the temperature during the compression is lower than the temperature during the expansion. While the lower temperature (during expansion) may be provided by the ambient air or water, the higher temperature during the expansion can be provided by:
A heat source such as burning fuel or nuclear reactor;
Thermal solar collector;
Hydrothermal heat;
Waste heat from industrial or other sources.

Alternatively, the proposed technology allows to use heat-sink and heat-providing media with temperature differences shifted in time. As an example, the diurnal (day/night) temperature difference of air can be used for the electrical power generation. The air in ItCAES can be compressed during the lowest, night-time air temperature, and be expanded during the highest, day-time air temperature. In addition, the expansion unit can be heated by sunlight or other means during the day in order to further increase the expanding air temperature. During the compression, the compression unit can be sprinkled with water or cooled by other means to further decrease the compressing air temperature.

The ItCAES can be built on a highly variable scale—between a fraction of a kilowatt and a multi-megawatt unit power.

While a preferred form has been described above and shown in the accompanying drawings, it should be understood that the applicant does not intend to be limited to the particular details described above and illustrated in the accompanying drawings, but intends to be limited only to the scope as defined by the following claims.

Therefore the foregoing description of the preferred embodiments have been presented to illustrate the principles and not to limit the scope of the claims to the particular embodiment illustrated. It is intended that the scope be defined by all of the embodiments encompassed within the following claims and their equivalents.

Generally speaking, the systems described herein are directed to compressed air energy storage systems. Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein. As used here, the term “concurrently” means substantially at the same time. As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

Unless defined otherwise, all technical and scientific terms used herein are intended to have the same meaning as commonly understood to one of ordinary skill in the art.

1. A method of pseudo-isothermal energy conversion between mechanical and pneumatic energy comprising the steps of:
providing a gas/liquid unit wherein the gas/liquid unit is a compression unit filled with gas and a liquid storage unit containing liquid, the compression unit having thermally conductive walls;
compressing the gas by pumping the liquid into the compression unit via a liquid pump and producing compressed gas;
concurrently transferring the heat created during the compression step through the walls of the compression unit; and
transferring the compressed gas into a compressed gas storage unit and thereby storing energy in the form of pneumatic energy of a compressed gas.

2. The method as claimed in claim 1 further including the step of filling the gas/liquid unit with gas and then repeating the compression steps.

3. The method as claimed in claim 2 wherein the heat is transferred to one of another gas or another liquid located outside of the compression unit.

4. The method as claimed in claim 2 wherein the heat is transferred to a heat sink liquid located outside of the compression unit and the heat sink is used for one of industrial purpose and domestic purpose.

5. (canceled)

6. (canceled)

7. The method as claimed in claim 1 wherein there is a valve between the compression unit and the gas storage unit.

8. The method as claimed in claim 1 wherein the compression unit is made of a plurality of connected vessels.

9. (canceled)

10. (canceled)

11. The method as claimed in claim 8 wherein the plurality of vessels are arranged in one of parallel flow communication, series or a combination of both.

12. (canceled)

13. The method as claimed in claim 1 wherein the compression unit includes a plurality of vessels arranged in series and the diameter of the vessels decreases as they approach the gas storage unit.

14. The method as claimed in claim 1 wherein the compression unit elements are positioned at an angle related to a horizontal plane such that the liquid flows upwardly to an exit.

15. (canceled)

16. (canceled)

17. (canceled)

18. The method as claimed in claim 1 wherein the liquid storage unit is a second compression unit.

19. (canceled)

20. (canceled)

21. (canceled)

22. The method as claimed in claim 1 wherein the method further includes steps for pseudo-isothermal expansion of gases and wherein gas/liquid unit is a compression/expansion unit and the method further includes expansion of gases including the steps of:
transferring compressed gas from the compressed gas storage unit into the compression/expansion unit which is initially filled with liquid, and pushing out an equal volume of the liquid from the compression/expansion unit;
allowing the compressed gas to expand thereby pushing liquid from the compression/expansion unit into the liquid storage unit via a liquid engine thereby transforming stored pneumatic energy in the form of compressed gas into mechanical energy;
concurrently heat consumed during the gas expansion step is transferred through the walls of the compression/expansion unit; and
filling the compression/expansion unit with liquid.

23. The method as claimed in claim 22 wherein the expansion of gases steps are repeated.

24. A method of pseudo-isothermal expansion of gases comprising the steps of:
transferring compressed gas from a compressed gas storage unit into an expansion unit and pushing out a portion of the liquid in the expansion unit;
the expansion unit having thermally conductive walls;
allowing the compressed gas to expand thereby pushing liquid in the expansion unit into the liquid storage unit via a liquid engine thereby transforming stored energy in the form of compressed gas into mechanical energy; and
concurrently heat consumed during the gas expansion step is transferred through the walls of the expansion unit.

25. The method as claimed in claim 24 further including the step of filling the expansion unit with liquid and repeating the steps.

26. The method as claimed in claim 24 wherein the heat is transferred from one of another gas or another liquid located outside of the expansion unit.

27. The method as claimed in claim 24 wherein the heat is transferred from a heat providing liquid located outside of the expansion unit and the heat providing liquid is used for one of industrial purpose and domestic purpose.

28. (canceled)

29. The method as claimed in claim 24 wherein the expansion unit is made of a plurality of connected vessels.

30. (canceled)

31. (canceled)

32. The method as claimed in claim 29 wherein the plurality of vessels are arranged in one of parallel flow communication, series or a combination of both.

33. The method as claimed in claim 24 wherein expansion unit includes a plurality of vessels arranged in parallel flow communication and of the same size.

34. The method as claimed in claim 24 wherein the expansion unit includes a plurality of vessels arranged in series and the diameter of the vessels decreases as they approach the gas storage unit.

35. The method as claimed in claim 34 wherein the expansion unit is positioned at an angle related to the horizontal plane such that the liquid flows downwardly to an exit.

36. (canceled)

37. (canceled)

38. (canceled)

39. The method as claimed in claim 24 wherein the liquid storage unit is a second expansion unit.

40. An apparatus for pseudo-isothermal energy conversion of compressed gases comprising:
a gas/liquid unit being filled with one of liquid, gas and a combination thereof, the gas/liquid unit having thermally conductive walls;
a liquid storage unit in flow communication with the gas/liquid unit;
a device between the liquid storage unit and the gas/liquid unit, wherein the device is one of a liquid pump, a liquid engine and a combined pump/engine;
a gas storage unit in flow communication with the gas/liquid unit;
wherein when liquid is pumped into the gas/liquid unit mechanical energy is converted to pneumatic energy and stored in the form of compressed gas and heat is produced and transferred through the thermally conductive walls and when the compressed gas is expanded the pneumatic energy is converted into mechanical energy and heat is consumed through the thermally conductive walls.

41.-56. (canceled)
